(19) United States
(12) Patent Application Publication
(10) Pub. No.: US 2010/0005015 A1
(43) Pub. Date: Jan. 7, 2010

(54) Electronic Invoice Generation, Storage, Retrieval and Management system

(75) Inventors: RAVNEET GHUMAN, Phoenix, AZ (US); ASHISH RAJ, JODHPUR (IN)

Correspondence Address: Ravneet Ghuman, 17440 N Tatum Blvd, Apt. #287, Phoenix, AZ, 85032, US

(73) Assignees: RAVNEET GHUMAN, Phoenix, AZ (US); ASHISH RAJ, JODHPUR (IN)

(21) Appl. No.: 12/497,516

(22) Filed: Jul. 2, 2009

Related U.S. Application Data
(60) Provisional application No. 61/078,368, filed on Jul. 4, 2008.

(51) Int. Cl. G06Q 10/00

(52) U.S. Cl. 705/30

(57) ABSTRACT

Conventional Paper Invoices are used as receipt of payment for services, products etc. These Invoices have to be maintained for stipulated time, dictated by the guarantees, warranties, post sales service agreement period etc and maintaining these invoices becomes difficult with time and growth in number.

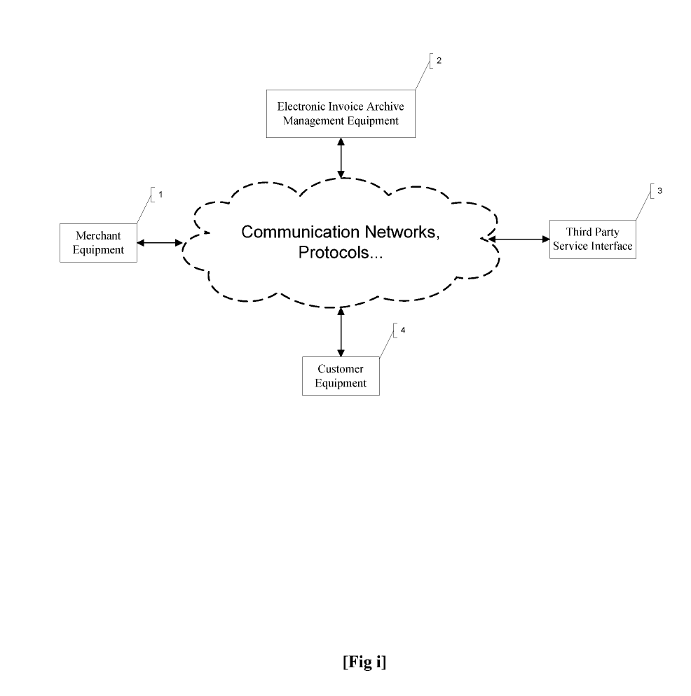

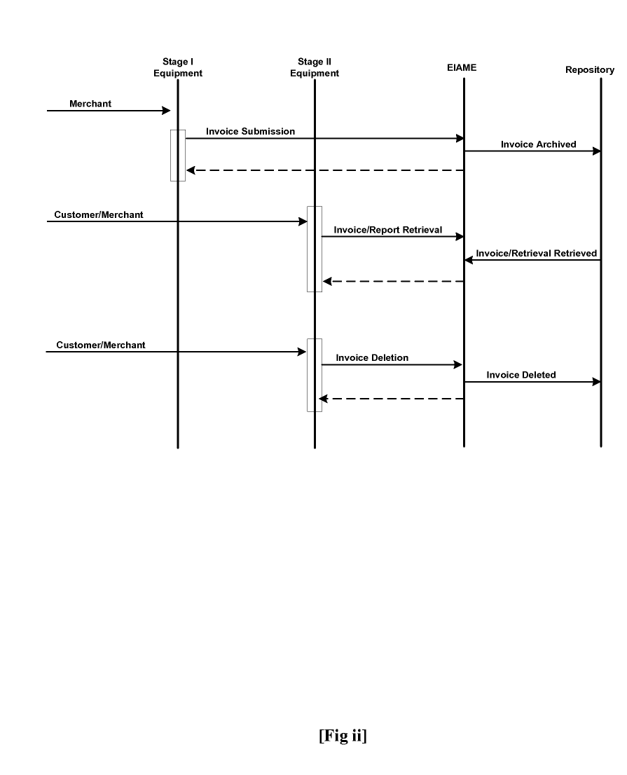

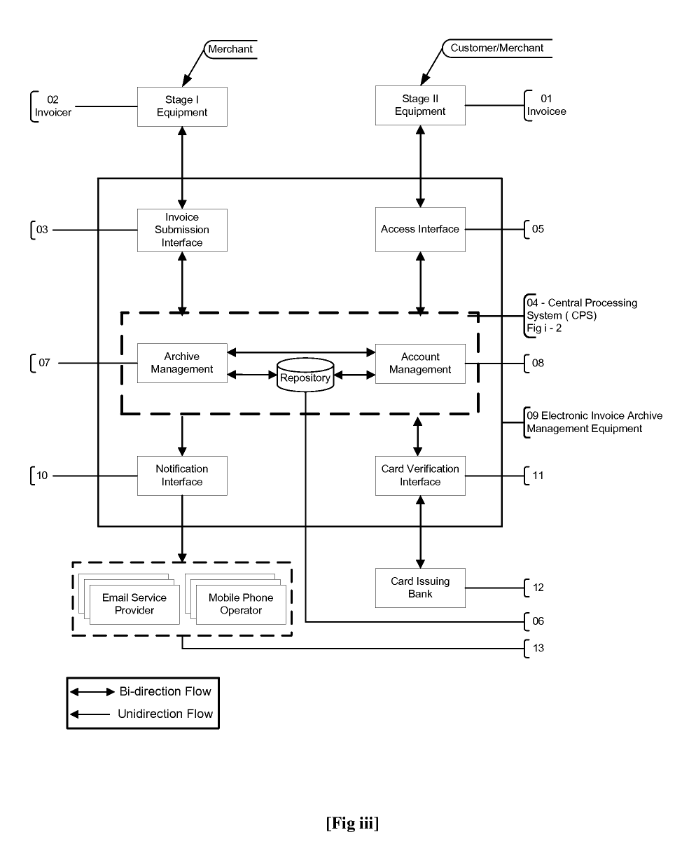

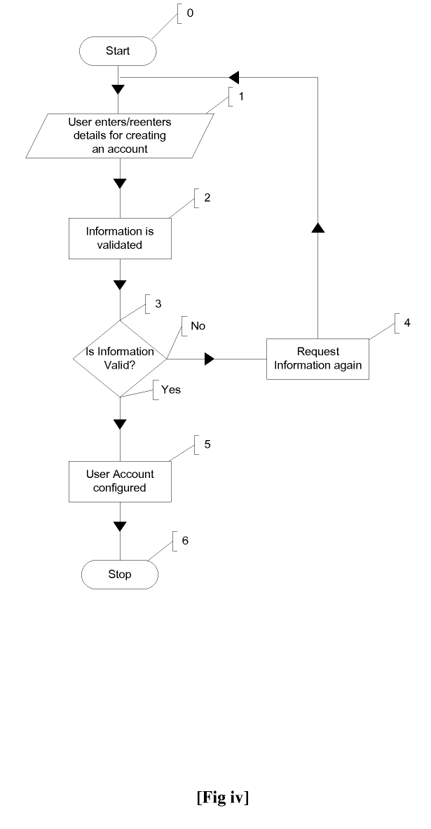

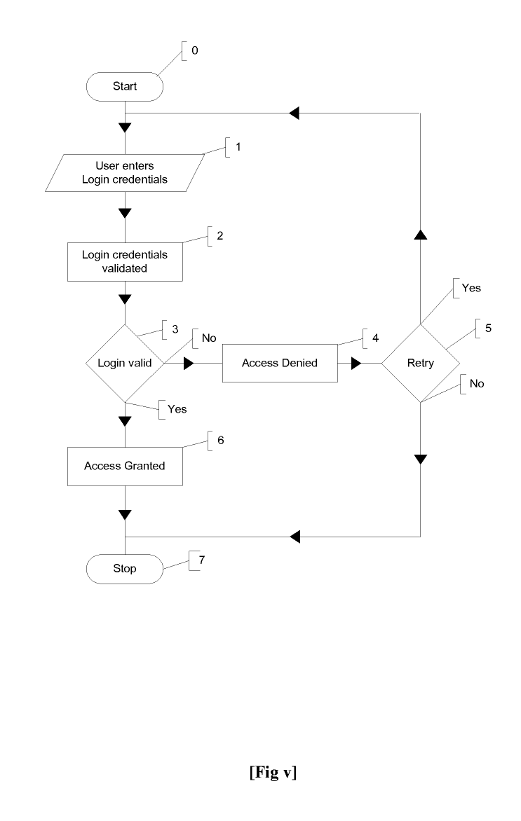

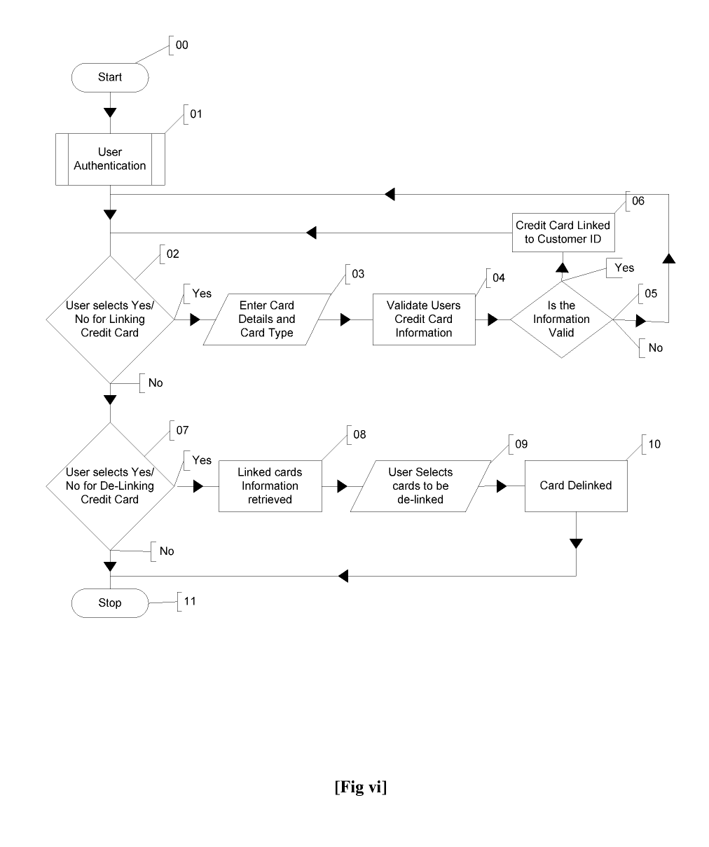

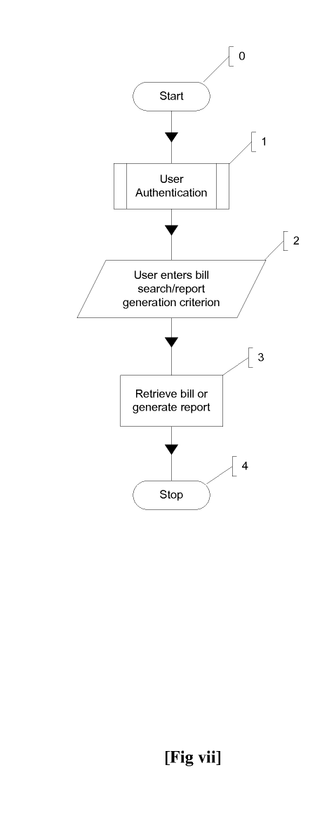

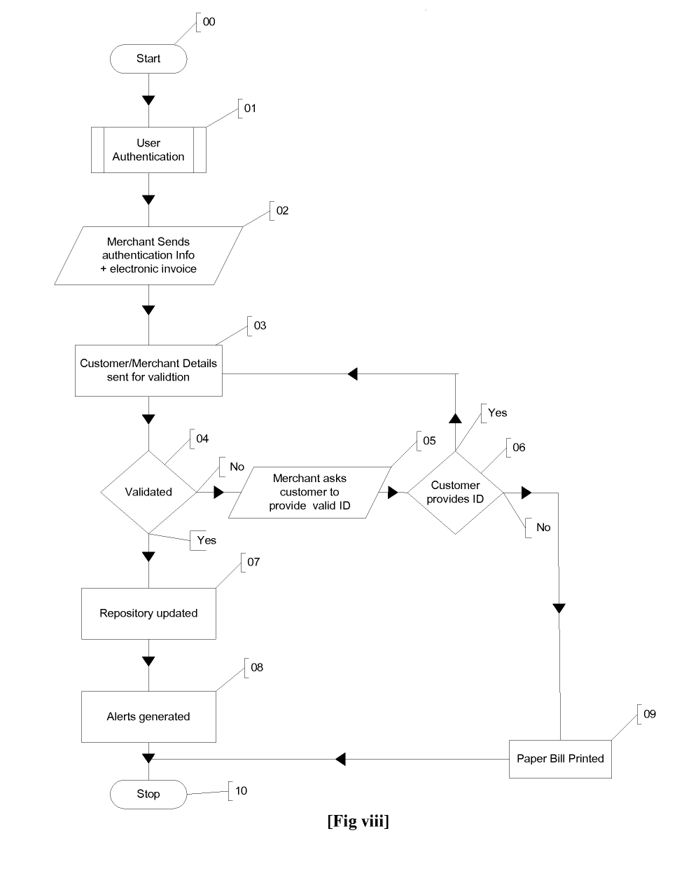

The present invention proposes a solution based on Electronic Invoices to overcome the problems associated with maintaining huge number of paper invoices for a long period of time.

Electronic Invoices are electronic presentation of paper invoices and are equivalent in all respects except that electronic medium is used instead of paper.

Other exciting possibilities, such as permanent electronic archival, easy global access through Internet and through various devices including handhelds, ATM's etc, exist.

The present invention not only solves the problems mentioned above but also eliminates the printing, infrastructure related costs.

Hence, the present invention helps Customers, Merchants in maintaining invoices with ease of time and global accessibility.

This non-provisional application takes priority date of Jul. 4, 2009 from previously filed provisional application U.S. 61/078,368.

### CROSS-REFERENCE TO RELATED APPLICATIONS

This non-provisional application is in continuation of provisional application No. 61/078,368 (EFS ID: 3569468 and Confirmation Number: 6822) filed on Jul. 4, 2008 and thus inherits Jul. 4, 2008 as its priority date.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention defines a system for Generation, Storage, Retrieval and Management of electronic invoices. It also specifies report generation by means of analytics on archived invoices and a method for notification of new invoices in the form of alerts.

### STATE OF THE ART

Many solutions have been proposed for the online electronic invoice presentment and for the purpose of online payments [U.S. Pat. Nos. 6,055,567 and 6,856,974B1 (Ganesan et al)]. Essentially, a customer is required to register with each invoicer (also referred to as Merchant) to be able to receive electronic invoices (online) to make online payments. One type of system requires customers to periodically visit online systems of each invoicer to check if, a new invoice has been presented for online payment or not. However with some online systems, customer can also opt to receive a notification by means of email, sms etc., whenever a new invoice is available.

The other type of system provides auto payment facility [U.S. Pat. No. 6,304,860 (Joseph B. Martin, Jr., D. Allen Hinkle et al)] wherein system automatically makes payment for registered billers i.e. whenever an invoice is generated, payments are realized from the aforementioned customer's account. In this case, the customer has to check the transaction history (of the bank account through which payment was made) or check with each biller or rely on a system generated notification, to be sure of success of automated payment. [U.S. Pat. No. 6,064,990 (Kevin Scott Goldsmith et al)] proposes to send financial account activity notifications to customers to enhance security.

In both of the above cases, nevertheless a detailed printed copy of invoice has to be mailed to the customer, unless otherwise specified by customer. Existing inventions only provide methods to present electronic invoices (in the form of a summary or a detailed copy which is available on merchant's website or sent to the customer in an email). Since present inventions do not provide method to either archive electronic invoices or consolidate presentments from different merchants(for purchases made at a physical or on an online store), none of the present inventions can provides methods to analyze consolidated archived invoices. This makes it difficult and time-consuming to track outflow of wealth in terms of products consumed & services availed, with paper invoices.

Furthermore, the customer's ability to avail the service of auto payment is subjected to bank's commitment to provide auto payment service and bank's contract with individual billers, whom customer wishes to interact with, to provide auto payment service. In addition to lack of centralized control the existing systems for online invoice presentment and online payments also lack uniformity as every invoicer has a different system with its own peculiarities. This entails considerable effort and vigilance on customer; one has to visit several different online systems periodically to view details of online invoice presentments. Some times the customer ends up creating accounts at each biller's website to view purchase history.

Current online invoice presentment and payment systems are not very suitable for ‘One Time Purchase and Payment’ model; however it does mainly exist to support the model wherein a customer is assumed to be a regular subscriber of a service and has to pay monthly invoices.

Current invoicing system still has a dependency upon printed invoices, this process has not only considerable operational cost but also suffers from the problems associated with management, storage, searching or maintaining an account of paper invoices which can easily perish over a period of time. The fact that these paper invoices need to be presented as a proof of purchase for various purposes like availing post sales service, guarantees, warranties, incase of disputes over quality of products/services, be it in legal proceedings or while returning the purchased items, availing discounts on subsequent purchases. And all these make preserving paper invoices for a long time a necessary and critical task. In addition, none of the present inventions addresses the problem of preserving paper invoices for long period of time.

Many Solutions have been proposed to reduce the printing costs but none provide an alternative to eliminate printing costs [U.S. Pat. No. 5,581,358 (Kaoru Seto, Atsushi Kashihara et al).

The above mentioned systems lack certain aspects while there is a third kind of system—e-commerce [U.S. Pat. No. 7,013,289 (Michel Horn, Thomas Scott Manaugh et al)]. These systems provide a platform to multiple vendors to sell their products but this type of systems do not integrate with any other vendor or entity but the merchant products they sell.

### BRIEF SUMMARY OF THE INVENTION

The present invention addresses the above mentioned problems, associated with paper invoices, summarized/detailed electronic invoices, their presentments, and non-uniform billing performed by different merchants, as it proposes
Electronic invoice generation (e-invoice).
Electronic transmission of e-invoice.
Electronic archival of e-invoice.
Electronic management of e-invoices.
Method to link various credit cards to the customers unique ID (also referred to as user account).
Method to retrieve archived e-invoices, based on different criterion.
Report generation—to present a summary of e-invoices
Global accessibility in terms of submission as well as their retrieval of e-invoices.

Objective
The main objective of this invention is to eliminate the dependency on conventional paper invoices.
Another main objective of this invention is to provide effortless means of archiving invoices electronically and quick retrieval of these stored invoices.
Another objective is to provide access for retrieval of invoices at all times globally.
Another primary objective is to provide alternative to serve as proof of sale of goods or services and receipt of payment.
Another primary objective is to reduce the cost associated with printing—paper, toner, electricity consumption, infrastructure setup and maintenance.
Another objective is to provide a facility to link credit cards with customer's account so as to eliminate the need of memorizing or carrying additional ID card (having details of customer's subscription to e-billing service) to be presented at a merchant establishment for receiving invoices in electronic format.
Another objective is to provide mechanism & interface for tracking outflow of wealth on products consumed and services availed.
Another objective is to notify customers through alerts for purchases, which would help in tracking and aid in preventing fraudulent transactions.

### BRIEF DESCRIPTION OF THE SEVERAL VIEWS OF THE DRAWING

[Fig i]—Shows system's key type of entities and their interaction.

[Fig ii]—Shows typical Life Cycle of an Invoice.

[Fig iii]—Shows exemplary embodiment.

[Fig iv]—Shows the one time user account setup procedure.

[Fig v]—Shows the user authentication procedure.

[Fig vi]—Shows the procedure to link a credit card with a customer account.

[Fig vii]—Shows the procedure to retrieve electronic invoice and analysis report.

[Fig viii]—Shows the procedure for electronic invoice submission and procedure to resolve customer account using credit card number.

### DETAILED DESCRIPTION OF THE INVENTION

Explanation of Terms Used in This Application

Electronic invoice: Electronic Invoices are electronic presentation of paper invoices and are equivalent in all respects except that electronic medium is used instead of paper. Similar to the conventional paper invoice, an electronic invoice can be generated by retail terminals operated by merchant, the customer himself or by web portals administering online purchases but these points of invoice generation are not limited to just retail, kiosks or e-commerce.

Credit card: In this specification, this term refers to credit cards (e.g. MasterCard, Visa etc) as well as charge cards (e.g. American express); debit card such as usable at ATM's and many other locations or other cards that are associated with a particular financial account of the user and hybrid thereof (extended payment card, bank debit cards, credit cum debit cards etc).

Equipment: The term ‘Equipment’ refers to an electronic device which can be programmed using software and can interface to networks. It can either be a software enhancement to existing hardware or vice versa or even a combination of both and can also be a new user interface to existing equipment.

Merchant: The term ‘merchant’ refers to an individual or an organization which sells goods or provides services be it retail stores, online stores etc.

Stage I equipment: Term ‘Stage I equipment’ is used to represent Equipment which generates electronic invoice, submits the same to the repository. A variety of existing devices and systems can be adapted to incorporate stage I equipment e.g. retails terminals, online portals, pay-and-use automatic dispensing machines, automated fuel pumps and other type of kiosks etc.

Customer: The term ‘customer’ refers to person or organization that is issued an invoice on account of payment against purchase of goods or avail of service.

Stage II equipment: The term ‘Stage II equipment’ represents an Equipment which helps merchants/customers in retrieving electronic invoices from the repository, creating user accounts and linking/delinking credit cards etc.

User: The term ‘user’ pertains to a person or an organization that interacts with electronic invoice generation, storage, retrieval and management system using Stage I or II equipment.

User account: The term ‘user account’ pertains to a unique software entity which is associated with an individual user and enables identification of the user and accordingly establishes authorization and access privileges.

Electronic invoice archive management equipment (EIAME): EIAME maintains electronic invoice archive and provides access interface.

Central processing system (CPS): CPS refers to a software entity which contains all the logic to process, archive, retrieve, and analyze electronic invoices. CPS is core part of electronic invoice archive management equipment.

System Overview

Electronic invoice generation, storage, retrieval and management system [i] consists of mainly three entities viz. ‘Stage I Equipment’ [i]-1, ‘Electronic Invoice Archive Management Equipment’ (EIAME) [i]-2 and ‘Stage II Equipment’ [i]-4. These entities are programmable devices, such as a general purpose computer, which can be adapted by the use of software to perform desired function. In a typical scenario, these entities would be geographically separate and would require a communication network for interaction. [i]-3 represents interaction with 3rd parties (which are external to the system) like credit card issuing companies etc.

Stage I and II equipments exists in plurality and are user's interface to EIAME [i]-2. While the Stage I equipment [i]-i is responsible for generation and transfer of electronic invoices to EIAME, Stage II equipment [i]-4 is responsible for retrieval of electronic invoices and other processed data from EIAME [i]-2.

Functions of EIAME [i]-2 include electronic invoice archival, retrieval and its management. It allows Stage I equipment [i]-1 to submit new invoices and users to retrieve their invoices and generate analysis reports. Both invoices and analysis reports can be transferred, downloaded and printed using Stage II equipment [i]-4.

EIAME [i]-2 associates each user with a unique account referred to as a user account which is used by the system for assigning access privileges, authorization and associating invoices.

Authorization information controls user access to perform operations viz. new invoice submission, retrieval, report generation etc. EIAME [i]-2 maintains authorization information for each user and assigns access privileges to users on invoice to invoice basis. A user can exercise only those operations for which he is authorized and can process only those invoices for which he has access.

System archives invoices for definite/indefinite period based on user's selection; however a user can also delete invoices at their own discretion. An invoice is accessible to the customer as well as the merchant and even if one deletes it. It remains accessible to the other user until that user also deletes it.

EIAME [i]-2 also provides customers with an option of linking credit cards with user account. Electronic invoice generated against such a credit card is automatically made available to that user. However option of linking credit card with user account is not mandatory and user's account number can also serve the same purpose i.e. electronic delivery of invoices, subject to user mentioning the account number while making purchase/payment.

It is quite possible that a physical device plays multiple roles, for example a retail terminal can incorporate both Stage I and II equipment or an online portal can be adopted to incorporate Stage I equipment [i]-1 or an ‘information kiosk’ and an ATM can incorporate Stage II equipment [i]-4. Furthermore these entities can be adapted to communicate over various types of communication networks like, including but not limited to, internet, LAN, WAN, NOVEL Netware etc.

EIAME is capable of generating alerts to notify the users about a new invoice. These alerts can be delivered via SMS, e-mail etc.

SMS alerts, credit card verification for linking etc is done through interaction with third parties referred to as third party interfaces.

Life Cycle of Invoice

As shown in step 1 of Fig [ii], Merchant generates an invoice and transfers it to EIAME using Stage I Equipment. This invoice is then archived in Repository.

Now, both Customer and Merchant can retrieve and view, download and print this archived invoice using Stage II Equipment as shown in Step 2 of Fig [ii].

If Customer or Merchant wishes to delete this archived invoice, Stage II Equipment, helps accomplish this (Step 3 of Fig [ii]).

Exemplary Implementation

Following section gives details of processes related to invoice generation, archival and retrieval; user account management, credit card linking and alert generation as performed by exemplary implementation.

Figure [iii] through [viii] provides an overview of an exemplary implementation of the present invention. The system as depicted in fig [iii] comprises of CPS [iii]-04 and interfaces, for accessing services provided by CPS, viz. ‘Invoice Submission Interface’ [iii]-03, ‘Access Interface’ [iii]-05, ‘Notification Interface’ [iii]-10 and ‘Card Verification Interface’ [iii]-11. These interfaces interact with the two functions in CPS [iii]-04, ‘Archive Management’ (AM) [iii]-07 and ‘Account Management’ [iii]-08.

CPS [iii]-04 consists of a repository, archive management and account management. Electronic invoice data, user account information and user specific data is maintained in the repository [iii]-06 by archive management and account management. Account management [iii]-08 maintains user related information, user's authorization rights and user's access privileges to invoices, details of credit cards linked to customers account and user preferences viz. alert delivery mode, invoice archival period etc. Account Management [iii]-08 also helps in user account creation, credit card & customer account linking/delinking. Archive Management [iii]-07 maintains electronic archive and facilitates invoice archival and retrieval.

Archive Management [iii]-07 and Account Management [iii]-08 interact with each other for they can be closely or loosely coupled. In one scenario, Archive Management needs to know user's authorization before archiving a new invoice and then it instructs Account Management to grant access privileges to users to the said invoice; in another scenario, Archive Management needs to know if a user has access privileges to an invoice while carrying out a retrieval operation.

While linking a credit card with customer account, Account Management validates credit card details and customer information using ‘Card Verification Interface’ [iii]-11, which interacts with the card issuing banks [iii]-12 for confirmation. Once validated, the specified credit card is linked to the customer's account and this information is stored into the repository [iii]-06.

Information stored in the repository [iii]-06 can only be accessed by authorized users using the interfaces provided by CPS. Data stored in repository is secured and encrypted.

A user retrieves invoices and analysis reports by interacting with Access Interface using the stage II equipment. Access Interface [iii]-05 also provides options for account creation, credit card linking/de-linking, viewing standard analysis reports and invoice retrieval etc.

A merchant submits an invoice using the stage I equipment [iii]-02. Stage I equipment transfers new invoices, Customer and Merchant Identification Information to Invoice Submission Interface (ISI) [iii]-03. ISI [iii]-03 validates consistency of Invoice, Merchant and Customer Identification Information and then passes it to CPS [iii]-04 for archival.

CPS [iii]-04 is capable of generating alerts through notification system [iii]-10 at advent of certain events like arrival of new invoice, linking/delinking of credit cards to customers account etc. A user can decide the method to be used for delivering alerts and can also opt to disable/enable notifications or even configure criteria for selective notifications.

User Account Creation

Fig [iv] describes the process of user account creation. The user [iii]-01 accesses the Access Interface [iii]-05 using stage II equipment and provides details as requested [iv]-1 like name, address etc. If required, Access Interface may request for additional details or may request for a correction [iv]-4 if it finds any inconsistencies [iv]-3 in details provided by the user [iv]-2. Access Interface [iii]-05 passes this information to Account Management [iii]-08 which then creates user account [iv]-5 by setting up user account related information in repository which includes information provided by the user and other housekeeping information like user's authorization rights, etc.

User Authentication

Fig [v] describes the process of user authentication, which takes place with every instance of invoice submission, retrieval and invocation of management operations. Stage I and II equipment may request user's credentials for authentication [v]-1 only once and as and when required can automatically supply the same, along with details of operation for which authorization is requested, to ISI [iii]-03 and Access Interfaces respectively. Account management validates login credentials [v]-2 and accordingly authorizes the users to perform specified operation [v]-6 which can be retrieval, submission or management.

Account management denies request to execute any operation if login credentials are invalid [v]-4 and Stage I and II equipment may request the user to retry [v]-5.

Credit Card and Customer Account Linking/Delinking

Fig [vi] describes the process of linking and delinking credit cards to customer's account. Customer connects to Access Interface [iii]-05 using stage II equipment and goes through authentication procedure [vi]-01.

Stage II equipment initiates credit card linking operation, if requested by user [vi]-02, and prompts the user to enter credit card details [vi]-03. These Credit card details are transferred to Access Interface [iii]-05. Account Management [iii]-08 then initiates verification process via card verification interface which communicates with card issuing banks to establish authenticity of the specified credit card [vi]-04. Finally, on successful verification [vi]-06, Account Management updates user account and additional information in repository.

Stage II equipment initiates credit card delink operation, if requested by user[vi]-07 and prompts the user to select [vi]-09 cards which need to be delinked from the list of already linked cards [vi]-08. Account management [iii]-08 checks card details and updates user account information in repository to reflect the requested change [vi]-10.

Retrieval Operation

Fig [vii] describes how a user can view archived invoices. A User connects [vii]-l to Access Interface [iii]-05 using Stage II equipment and goes through authentication procedure [vii]-01. One can either select option to view a single invoice or opt to select multiple invoices based on a certain criterion or generate one of the available standard analysis reports [vii]-2. The idea behind this is to provide the end user with utilities to search for old invoices, filter them on certain criterion or view summary report/trends of spending pattern over time or other available dimensions. Access Interface [iii]-05 performs the requested operation [vii]-3 by sending request to CPS [iii]-04, which retrieves the data from the Repository [iii]-06. Different levels of access and functionality is provided depending on the type of user—merchant or customer.

Invoice Submission

Fig [viii] describes the process by which a merchant submits invoice. Merchant connects to ISI [iii]-03 through stage I equipment and goes through authentication procedure [v]. Stage I equipment then transfers invoice and customer identification information which can be either user account number or credit card number used for making payment and invoice [viii]-2. After successful validation [viii]-4 of customer identification information [viii]-3, Account management [iii]-08 instructs Archive management [iii]-07 for archival of invoice in repository [iii]-06. Archive management [iii]-07 now triggers the notification interface [iii]-10 to generate alerts [viii]-08. If customer identification fails then archive management aborts the operation and Stage I equipment prompts the user to retry [viii]-6.

### CLAIMS

Attached

### ABSTRACT OF THE DISCLOSURE

Attached

### DRAWINGS

Attached

### DECLARATION

Attached form PTO/SB/01A

### SEQUENCE LISTING

Not Applicable

1) An Electronic Invoice Management System maintaining Electronic Invoice Repository providing remote access to
a. Merchants for submitting new electronic invoices for archival,
b. Merchants and Customers for viewing, downloading or printing archived electronic invoices, pertaining to them,
c. Merchants and Customers for generating, viewing or printing analysis reports on archived invoices, pertaining to them,
d. Merchants and Customers for managing archived electronic invoices, pertaining to them.
where in, said electronic invoice is further
e. Suitable for transmission over a communication network for submission and retrieval,
f. Suitable for electronic processing operations such as archival, regeneration and analysis.

2) The system according to claim 1, where in said electronic invoice includes information about merchant.

3) The system according to claim 1, where in said electronic invoice include information about customer.

4) The system according to claim 1, where in said electronic invoice include information related to sale or service.

5) The system according to claim 3, where in said customer information includes customer's unique Account number.

6) The system according to claim 1, where in said electronic invoice includes any information as may be required by the present invention for purpose such as processing, storage, security or management.

7) The system according to claim 1, where in said remote access is provided to Merchant and Customer by Remote Access Equipments viz. Stage-I and Stage-II equipment.

8) The system according to claim 7, where in said Remote Access Equipment are electronic devices which can be customized and controlled by software programs and/or can be actual retail terminal, kiosk, an online portal.

9) The system according to claim 8, where in said Remote Access Equipment is further adapted to communicate with electronic invoice repository over a communication network.

10) The system according to claim 8, where in said Stage-I equipment is further adapted to generate, transmit electronic invoices to electronic invoice repository.

11) The system according to claim 8, where in said Stage-II equipment is further adapted to delete, retrieve; display or print electronic invoices/analysis reports.

12) The system according to claim 7, where in Remote Access Equipments access Remote Access Interface provided by Electronic Invoice Management Equipment, which is a combination of customizable hardware and software and can communicate over a network.

13) The system according to claim 12 where in Remote Access Interface can be accessed through said Remote Access Equipment and can further be instructed to carry out operation/functions.

14) The system according to claim 13, where in said Remote Access Interface is further adapted to accept instructions to retrieve archived electronic Invoices/Analysis Reports from Electronic Invoice Repository and transmit the same to the said remote access Equipment.

15) The system according to claim 13, where in said Remote Access Interface is further, adapted to accept instructions to link/de-link credit cards with customer account.

16) The system according to claim 13, where in said Electronic Invoice Management Equipment is further, adapted to accept instructions to delete archived invoices from Electronic Invoice Repository.

17) The system according to claim 13, where in said Access Interface is further adapted to accept instructions to create User Account.

18) The system according to claim 13-17, where in said Electronic Invoice Management Equipment is further adapted to provide Remote Access Interface to Remote Access Equipment Equipment, to communicate over a network to carry out said instructions.

19) The system according to claim 18, where in said Electronic Invoice Management Equipment can be realized with single or a cluster of units.

20) The system according to claim 18, where in said Electronic Invoice Management Equipment is further adapted to maintain user's access privileges and authorization information and further maintains user account.

21) The system according to claim 18, where in said Electronic Invoice Management Equipment is further adapted to archive electronic invoices.

22) The system according to claim 18, where in said Electronic Invoice Management Equipment is further adapted to regenerate archived electronic invoice.

23) The system according to claim 18, where in said Electronic Invoice Management Equipment is further adapted to generate analysis reports from archived invoices.

24) The system according to claim 18, where in said Electronic Invoice Management Equipment is further adapted to transmit electronic invoices and analysis reports over a network.

25) The system according to claim 18, where in said Electronic Invoice Management Equipment is further adapted to create user accounts.

26) The system according to claim 18, where in said Electronic Invoice Management Equipment is further adapted to resolve customer's account from credit card number.

27) The system according to claim 18, where in said Electronic Invoice Management Equipment is further adapted to resolve customer's account by interacting with credit card issuing bank.

28) The system according to claim 18, where in said Electronic Invoice Management Equipment is further adapted to have a Credit Card Validation Interface.

29) The system according to claim 28, where in said Electronic Invoice Management Equipment is further adapted to cater to customer's request to link or de-link credit card to his account by interacting with Card Issuing Banks, if required.

30) The system according to claim 12, where in said Electronic Invoice Management Equipment is further adapted to authorize merchant and customer for interaction with it.

31) The system according to claim 12, where in said Electronic Invoice Management Equipment is further adapted to generate notifications, where in said notification can be realized by electronic mails, SMS (Short Message Service) and summary reports.

32) The system according to claim 7-11, where in said Stage-I and Stage-II can be embedded into other devices like ATM, electronic kiosk's etc.

33) An Electronic Invoice Management System substantially as herein described with reference to the accompanying drawing.
